(19) United States
(12) Patent Application Publication
(10) Pub. No.: US 2007/0038760 A1
(43) Pub. Date: Feb. 15, 2007

(54) Information processing apparatus and method

(75) Inventor: Toshiyuki Arai, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/586,139

(22) Filed: Oct. 24, 2006

Related U.S. Application Data
(62) Division of application No. 09/781,496, filed on Feb. 12, 2001.

(30) Foreign Application Priority Data
Feb. 14, 2000 (JP) P2000-039753

(51) Int. Cl. G06F 15/16

(52) U.S. Cl. 709/227

(57) ABSTRACT

An information processing apparatus having a receiver, a user identifier generator, a generation source identifier memory, and a transmitter. The receiver receives a request transmitted from a terminal device. The user identifier generator generates a user identifier corresponding to the request. The generation source identifier memory stores a generation source identifier to identify a generation source of the user identifier. The transmitter transmits the generated user identifier and the stored generation source identifier to the terminal device.

### BACKGROUND OF THE INVENTION

The present invention relates to an information processing apparatus in a system which is capable of providing various information or selling information and commodities via communication lines for example. And more particularly, it relates to an information processing apparatus which opens a homepage for providing various information or rendering services, including sales of information and commodities, to user terminals.

Recently, there is widely utilized a network system connected via communication lines, such as the Internet. In the Internet, a multiplicity of individual persons and groups open homepages to provide a variety of information or to sell information and commodities widely for the general public.

It is also known that any ordinary user is enabled to easily access some other homepage relative to one homepage by forming, on one homepage, an address link to the other homepage.

In opening a homepage as a means of business for example and selling commodities on such a homepage, there is a case of requesting introduction or the like on other homepages.

For example, a commodity sale homepage “A” owned by an individual person or a firm is introduced or publicized on another homepage “B”, and further a link is formed according to a request. In this case, any ordinary user having accessed the homepage “B” knows the existence of homepage “A” and then accesses the homepage “A” to enjoy shopping on the Internet.

When an introduction of one homepage “A” is made on another homepage “B” in this manner, it is generally customary that the owner of homepage “A” pays a fee for publicity, advertisement or introduction to the owner of homepage “B”.

Practically, the fee is determined depending on, e.g., a fixed monthly expense, a partial area of introduction on the homepage and so forth.

However, it is of course impossible to accurately calculate the economic effect attained due to introduction or publicity on the side of homepage “A”, and the fee for the introducer or publicizer on the side of homepage “B”. is not always adequate.

For example, when there is nearly none of actual introduction, payment of the fee from the homepage “A” side is considered to be extremely disadvantageous. On the contrary, when there are a great number of actual introductions, the homepage “B” side may be dissatisfied with the fee to be received.

Further, when introduction or publicity is carried out also on a homepage “C” in addition to a homepage “B” and practically almost all the users access the homepage “A” via the homepage “C”, then it is inadequate to pay the same fee of publicity or introduction to both the owner of homepage “B” and the owner of homepage “C”.

### SUMMARY OF THE INVENTION

In view of the circumstances mentioned above, it is an object of the present invention to provide a system which is capable of realizing proper payment of an adequate fee between two users in case introduction or the like is carried out between homepages for example.

According to one aspect of the present invention, there is provided an information processing apparatus comprising a receiver, a user identifier generator, a generation source identifier memory, and a transmitter. The receiver receives a request transmitted from a terminal device. The user identifier generator generates a user identifier corresponding to the request. The generation source identifier memory stores a generation source identifier which identifies the generation source of the user identifier. And the transmitter transmits the generated user identifier and the stored generation source identifier to the terminal device.

According to another aspect of the present invention, there is provided an information processing apparatus comprising a receiver, an authenticator and a payment processor. The receiver receives a user identifier transmitted thereto from a terminal device, and also a generator identifier which indicates the generation source of the user identifier. The authenticator authenticates an access to information in accordance with the received user identifier and generation source identifier. And the payment processor executes a process for payment of a fee to the generation source indicated by the generation source identifier in accordance with the authentication result.

More specifically, in introducing some other homepage for example as specific information to a general user's terminal device, a user identifier is given to the relevant user, and also a generation source identifier indicating the information processing apparatus as an introduction source is given to the relevant user, whereby the user of the terminal device is enabled to utilize the user identifier and the generation source identifier when accessing such specific information.

Further, when accessing the specific information, authentication is performed by means of the user identifier and the generation source identifier, and also the generation source such as an introduction source is exactly identified by the generation source identifier, so that a process for payment of a fee for introduction, publicity or the like is executed to consequently realize proper payment of the adequate fee.

Thus, in the present invention, the information processing apparatus as an introduction source issues a user identifier and a generation source identifier to a user's terminal device, while the other information processing apparatus as an introduction destination performs authentication by means of the user identifier and the generation source identifier in response to an access from the user's terminal device to the specific information. And further the generation source such as an introduction source is exactly identified by the generation source identifier, whereby a process of paying the fee for introduction, publicity or the like is executed.

Therefore, in the information processing apparatus serving as an introduction destination, the introduction source can be exactly identified for proper payment of the adequate fee for introduction, publicity or the like, hence achieving advantageous effect to realize a pertinent system adapted for both the introduction source and the introduction destination.

Moreover, at the time of transferring the user identifier and the generation source identifier to the user's terminal device from one information processing apparatus serving as an introduction source, such identifiers are transferred also to the other information processing apparatus where the specific information is held, i.e., to the introduction destination as well. Consequently, in the information processing apparatus serving as the introduction destination, it becomes possible to accurately grasp the user identifier and the generation source identifier to eventually expedite payment of the adequate fee.

The above and other features and advantages of the present invention will become apparent from the following description which will be given with reference to the illustrative accompanying drawings.

### BRIEF DESCRIPTION OF THE DRAWINGS

FIG. 1 is a block diagram of a system constructed according to an embodiment of the present invention;

FIG. 2 is an explanatory diagram of function blocks showing an introduction source homepage side in the embodiment;

FIG. 3 is an explanatory diagram of function blocks showing an introduction destination homepage side in the embodiment;

FIG. 4 is a flowchart of a processing routine executed on the introduction destination homepage side in the embodiment;

FIG. 5 is an explanatory diagram of a picture for user registration in the embodiment;

FIG. 6 is an explanatory diagram of a picture for issue of a user password and an introduction password in the embodiment;

FIG. 7 is an explanatory diagram of a picture for entrance to a homepage in the embodiment;

FIG. 8 is an explanatory diagram of a picture for confirmation of an introducer in the embodiment;

FIG. 9 is a block diagram of a system constructed according to another embodiment of the present invention;

FIG. 10 is an explanatory diagram of function blocks showing an introduction destination homepage side in the embodiment;

FIG. 11 is a flowchart of a processing routine executed on the introduction destination homepage side in the embodiment; and

FIG. 12 is a block diagram showing an exemplary configuration of an embodiment which represents a computer where the present invention is applied.

### DETAILED DESCRIPTION OF THE PREFERRED EMBODIMENTS

Hereinafter a preferred embodiment of the present invention will be described below in detail. It is supposed in this embodiment that an introduction source homepage and an introduction destination homepage are existent as homepages (HP) stored in servers which are connected to a network such as the Internet, and monetary transfer such as payment of an introduction fee or a publicity fee is executed from the destination homepage to the source homepage. The information processing apparatus of the present invention has hardware or software to generate such introduction source homepage and introduction destination homepage.

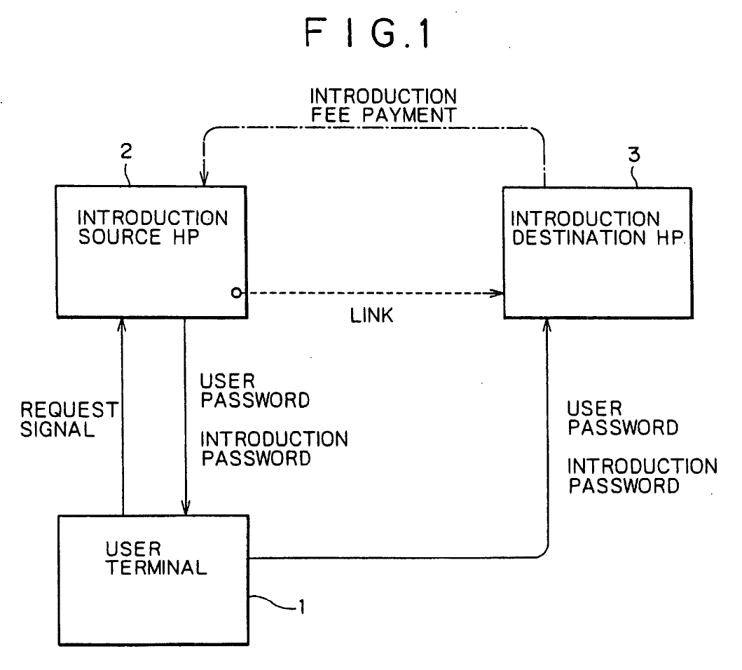

FIG. 1 is a block diagram showing an exemplary configuration of a system which comprises a multiplicity of terminals connected mutually through the Internet and servers having homepages. It is defined in this diagram that, since there exists a possibility that the homepages of both the introduction source and the introduction destination are stored in the same server, the expression as source homepage (HP) and destination homepage (HP) in this system configuration includes the hardware having a function to display each homepage and a function of CGI (Common Gateway Interface) and so forth to execute a program in accordance with any request from each user terminal, and also includes entire homepages generated by such hardware. FIG. 1 shows a user terminal 1, an introduction source homepage 2, and an introduction destination homepage 3. It is to be understood that the user terminal 1 shown in the diagram represents merely an example of multiple terminals in the world, and the homepages 2 and 3 also represent similar examples. Further, the introduction source and the introduction destination are not specific ones, and the source homepage 2 shown in FIG. 1 for example may be a destination to be introduced by some other unshown homepage.

In FIG. 1, the destination homepage 3 is introduced or publicized on the source homepage 2, and a link is formed from the source homepage 2 to the destination homepage 3. Therefore, when the user terminal 1 has accessed the source homepage 2, it is possible on the source homepage 2 to know the existence or contents of the destination homepage 3, and also possible to access the source homepage 3 easily via the link. In this case, naturally the user terminal 1 is enabled to access the destination homepage 3 directly without passing through the source homepage 2.

It is so contracted here that the owner of the destination homepage 3 pays an introduction fee to the owner of the source homepage 2.

In this system, when the user terminal 1 wants to access the destination homepage 3 after accessing the source homepage 2 and reading the introduction or publicity displayed thereon, the user terminal 1 transmits a request signal to the source homepage 2 for issue of a user password and an introduction password from the source homepage 2.

The user password is an identifier given uniquely to the user terminal 1. And the introduction password is an identifier which indicates the source homepage 2 and also indicates the generation source of the user password.

Further, the introduction password is an identifier given by the destination homepage 3 to the source homepage 2 according to the aforementioned contract for payment of an introduction fee, whereby the destination homepage 3 is enabled to exactly identify the source homepage 2.

After acquiring the user password and the introduction password thus issued, the user terminal 1 is permitted to enter the source homepage 3 by means of such user password and introduction password.

In this case, it may be so arranged that the destination homepage 3 inhibits the user terminal 1 from entering there if such user password and introduction password are not used. However, in this embodiment, an explanation will be given on exemplary conditions that the user terminal 1 is permitted to enter the destination homepage 3 without such user password and introduction password.

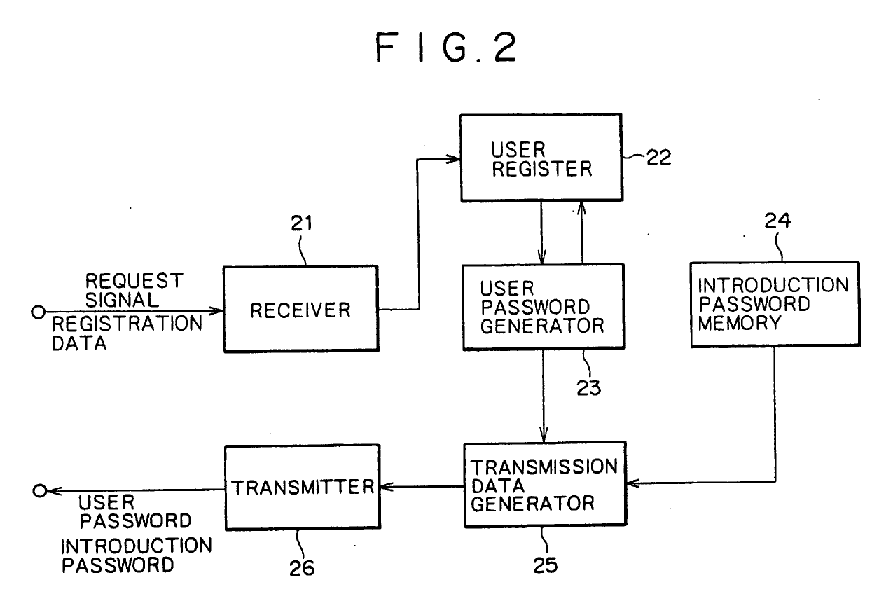

FIG. 2 is a block diagram showing hardware functions on the side of source homepage 2. This function block diagram shows only the component blocks functioning as the source homepage 2 which is an introducer to other homepages. Each function block may be composed of hardware including IC, memory and so forth.

As shown in FIG. 2, the function blocks consist of a receiver 21, a user register 22, a user password generator 23, an introduction password memory 24, a transmission data generator 25, and a transmitter 26.

The receiver 21 is a block to receive the aforementioned request signal from the user terminal 1. In issue of a user password, user registration is necessary in this embodiment. Therefore, the receiver 21 further has a function to receive data for such user registration from the user terminal 1.

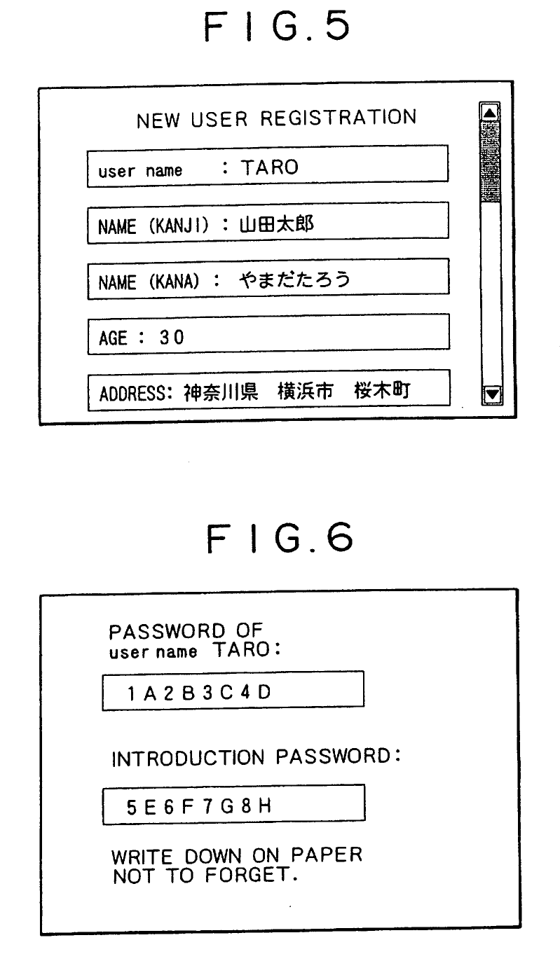

A user registration picture is prepared on the source homepage 2 as shown in FIG. 5, and when the user terminal 1 transmits a request signal, individual information is inputted on the picture of FIG. 5, and such individual information is transmitted as registration data together with the request signal.

For example, required individual information to be inputted includes user name, name in kanji characters, kana letters to be attached thereto, age, address and so forth. If kana letters are needed for the Japanese name written in kanji characters as in this example, it is preferred to prepare such a column of kana letters to be attached, but in the case of any English name or the like which needs none of such kana letters, this column may be omitted.

When the operator of the user terminal 1 has completely inputted the individual information on such a registration picture and transmitted a request signal with the registration data, the information is received by the receiver 21. Subsequently the receiver 21 extracts, from the request signal thus received, a specific identifier indicative of the request signal for example to thereby detect reception of the request signal, then extracts the received registration data, and transfers the extracted registration data to the user register 22.

The user register 22 stores the registration data to thereby execute user registration. And in response to such registration, the user password generator 23 generates a user password unique to the registered user. For example, a random value is generated as a user password by a random value generation means or the like. The user password thus generated is transferred to the user register 22 to be thereby registered correspondingly to the registration data.

Further the user password thus generated is transferred as transmission data to the transmission data generator 25.

The introduction password memory 24 stores the introduction password allocated from the destination homepage 3 to the source homepage 2.

The stored introduction password is transferred to the transmission data generator 25 together with the user password generated as mentioned above.

Subsequently the transmission data generator 25 generates both the introduction password and the user password as transmission data, and then transfers the same to the transmitter 26. Thereafter the transmitter 26 transmits the transmission data, i.e., the introduction password and the user password, to the user terminal 1 in conformity with a predetermined network protocol.

Consequently, the user terminal 1 displays such a picture as one shown in FIG. 6. Thus, the operator of the user terminal 1 is enabled to know the allocated user password and the introduction password.

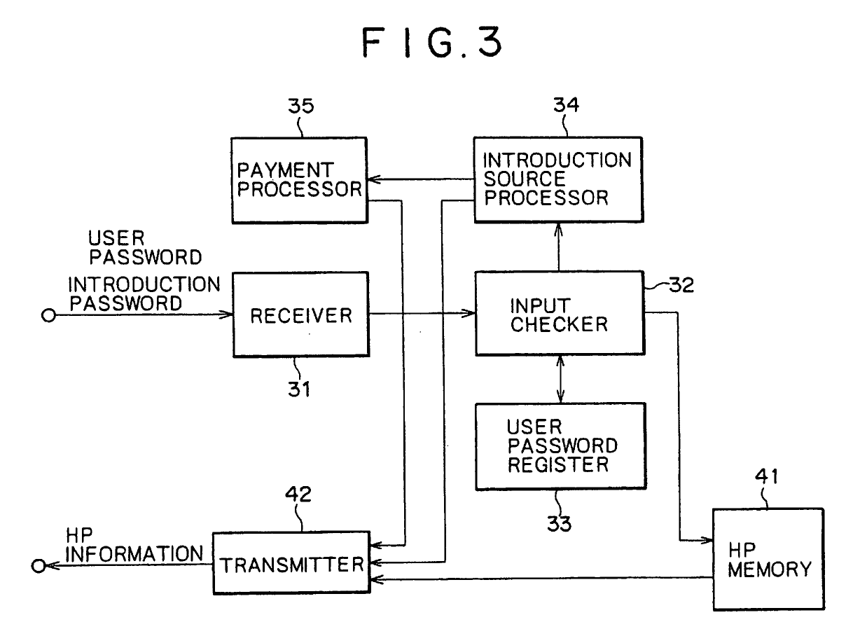

FIG. 3 is a block diagram showing hardware functions on the side of destination homepage 3. This function block diagram shows only the component blocks functioning as the destination homepage 3 which is an introduction destination from other homepages. Each function block may be composed of hardware including IC, memory and so forth.

As shown in FIG. 3, the function blocks consist of a receiver 31, an input checker 32, a user password register 33, an introduction source processor 34, a payment processor 35, a HP memory 41, and a transmitter 42.

The receiver 31 has a function of receiving the user password and the introduction password transmitted to the destination homepage 3 upon access from the user terminal 1 to the destination homepage 3, and another function of confirming if the user password and the introduction password have been properly received.

The input checker 32 has a function of checking the user password and the introduction password transferred from the receiver 31 at the entrance of the user terminal 1 to the destination homepage.

The user password register 33 has a function of storing the user password of the user having entered the destination homepage. The registration data becomes information for making a decision as to whether the user enters for the first time or the second or subsequent time.

The introduction source processor 34 has a function of storing the introduction source password issued to some other homepage, and also a function of calculating the introduction records in accordance with the introduction source password transmitted from the user terminal 1.

The payment processor 35 has a function of paying or calculating the introduction fee to the introducer (owner of introduction source homepage) in accordance with the introduction records calculated by the introduction source processor 34. In this stage, the function may be mere calculation of the introduction fee corresponding to the introduction records relative to each of individual introducers, or may include accounting, remittance and notification for payment of the introduction fee.

The HP memory 41 transfers the stored homepage in an HTML format to the transmitter 42 in accordance with the result of checking each password by the input checker 32.

And the transmitter 42 transmits the homepage data of the HTML format, which has been transferred thereto from the HP memory 41, to the user terminal 1 in conformity with a predetermined network protocol.

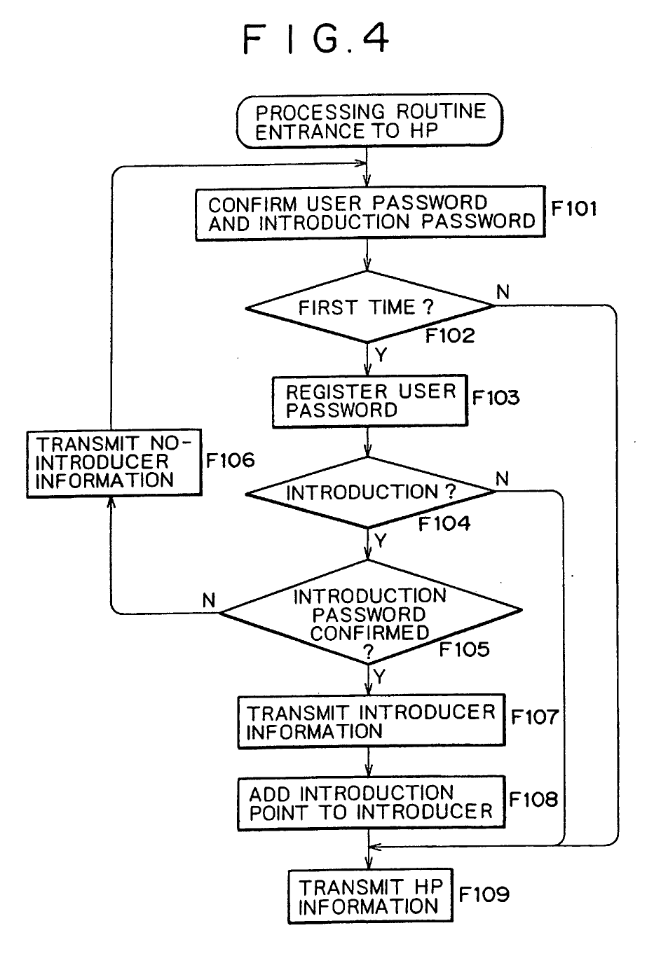

An exemplary processing routine executed in the destination homepage 3 having the function blocks of FIG. 3 will now be explained below with reference to FIG. 4. This processing routine is executed when the user terminal 1 enters the destination homepage 3.

In response to an access from the user terminal 1, first the destination homepage 3 confirms the user password and the introduction password at step F101 in FIG. 4.

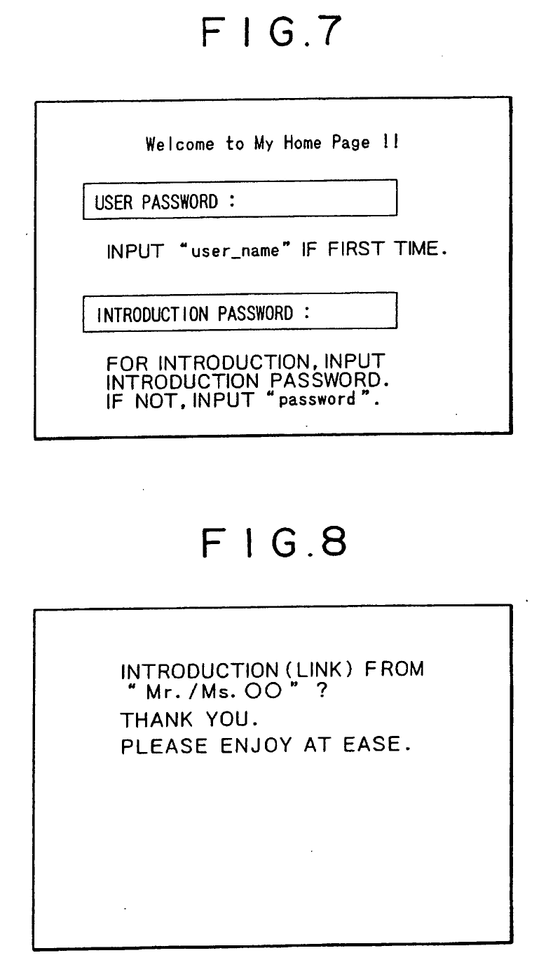

For example, the destination homepage 3 transfers, in response to an access from the user terminal 1, the homepage information of FIG. 7 in the HTML format to the user terminal 1, which then presents the picture of FIG. 7 as a homepage pre-entrance picture. Then the destination homepage 3 urges the user of the user terminal 1 to input and transmit the user password and the introduction password.

In case the user password and the introduction password have already been issued from the source homepage 2 as described above, the user having viewed the picture of FIG. 7 can input such passwords on the picture of FIG. 7 and transmit the same to the destination homepage 3.

Pertinent input of the user password and the introduction password from the user terminal side is allowed only when both of the user password and the introduction password have already been issued from the source homepage 2 to the user terminal 1. That is, such input is allowed only in case an introduction has already been rendered from the source homepage 2 to the destination homepage 3.

In the present invention, there may be contrived an example where entrance to the destination homepage 3 is permitted only after such a proper introduction. However, an explanation will be given here on another processing example where entrance is permitted even without any introduction.

In the case of a non-introduced user, the user inputs letters to the picture of FIG. 7 in accordance with the guide shown on the picture. For example, the user inputs “user name” as a user password temporarily, and “password” as an introduction password temporarily.

At step F101, the receiver 31 receives the user password and the introduction password transmitted thereto from the user terminal 1 and, after confirming that both the user password and the introduction password have been properly received, transfers the user password and the introduction password to the input checker 32. Subsequently at step F102, the input checker 32 makes a decision as to whether the user enters the destination homepage 3 for the first time or not.

At this step, the entrance is regarded as the first time by the input checker 32 in case the user password is “user name” or the input user password is any one unregistered in the user password register 33.

When the user password is any other than “user name” in the first entrance and the input password is different from any of those registered already in the user password register 33, then the input password is registered as a new entrant at step F103 by the user password register 33. The processing routine may be so modified that, when the input checker 32 has regarded that the input user password is a character string not generated by the source homepage 2, the user password register 33 does not register the user password.

Accordingly, the decision at step F102 as to whether the user password inputted by the user is the first entrance or not can be made by confirming the presence or absence of a registration of the input user password in the user password register 33.

In case the input user password has already been registered, i.e., in the second or subsequent entrance, the operation proceeds from step F102 to step S109 directly, and then the homepage data stored in the HP memory 41 is transmitted to the user terminal 1 via the transmitter 42.

After registration of the user password at step F103 in the first entrance, a decision is made at step F104 by the input checker 32 as to whether the introduction is present or not. That is, the input checker 32 checks if the introduction password is inputted or not.

If the result of this decision signifies no input of the introduction password, i.e., “password” and the temporal password are inputted, the result is regarded as no introducer, and then the operation proceeds from F104 to step F109 directly, and the homepage data stored in the HP memory 41 is transmitted to the user terminal 1 via the transmitter 42.

In case the result of the above decision signifies input of the introduction password, the input introduction password is confirmed at step F105. That is, the introduction source processor 34 confirms if the input introduction password is the one stored in the introduction source processor 34. This process is executed to confirm if the introduction password is the one allocated by the relevant destination homepage 3 to the other source homepage 2.

If the input introduction password is not coincident with the one stored in the introduction source processor 34, the introduction source processor 34 generates, at step F106, no-introducer information which indicates the absence of an introducer and transmits such information to the user terminal 1 via the transmitter 42, and then the operation returns to step F101, thereby requiring the user to input the introduction password again.

In case the input introduction password is coincident with the one already registered, the operation proceeds to step F107, where the introduction source processor 34 transmits the introducer information to the user terminal 1 via the transmitter 42. Then in the user terminal 1, the picture of FIG. 8 for example is displayed to confirm that the destination homepage 3 has been accessed through the introduction (link) from the source homepage 2.

Subsequently at step F108, the introduction source processor 34 executes a process of adding an introduction point relative to the owner of the source homepage 2 which represents the introducer and contracts with the destination homepage 3 for payment of the introduction fee.

The introduction point signifies a value indicating the introduction record which is stored correspondingly to the introduction password in the introduction source processor 34 for example.

After completion of the above process, the operation proceeds to step F109, where the homepage data stored in the HP memory 41 is transmitted to the user terminal 1 via the transmitter 42.

The processing routine mentioned above is executed at entrance from the user terminal 1 to the destination homepage 3, so that adequate payment of the introduction fee can be carried out from the owner of the destination homepage 3 to the owner of the source homepage 2.

More specifically, according to the above processing routine, the introduction point relevant to the introducer is added only when the user terminal has entered for the first time to the destination homepage 3 via the introducer (source homepage 2). The introduction point is not added in the second or subsequent entrance even through the link from the introducer, because the destination homepage 3 was introduced in the past and the entrance this time is not regarded as “introduction”. If the result of the decision at step F102 signifies a first entrance and “user name” is inputted, naturally the introduction password is inputted as “password”, so that it is decided to be no-introduction at step F104, and therefore no point is added to the introducer. Further, when an access from the user terminal 1 is made directly without passing through the introducer, naturally no introduction point is added either.

That is, the introduction point is added to the introducer only when real effect of introduction is recognized.

Consequently, in the destination homepage 3, it is possible by the payment processor 35 to confirm the introduction point relevant to each introducer such as once per month for example, and to count the amount of money corresponding to the introduction point. That is, the exact amount to be paid according to the introduction record can be calculated. Thereafter the introduction fee of the calculated amount may be paid to the introducer in conformity with predetermined office work. For example, the destination homepage 3 pays the introduction fee into the bank account of the source homepage 2 by transferring the due amount. Such monetary transfer may be executed automatically by transmitting an identification indicative of the destination homepage 3 as a payer, the bank account number of the source homepage 2 and the amount of the introduction fee from the payment processor 35 directly to an accounting center on the network.

According to such a system, it becomes possible to achieve a satisfactory contract convenient for both the introduction source and the introduction destination.

Even when there are a plurality of introducers, it is a matter of course that an introduction point relative to each introducer is added individually in accordance with the relevant introduction record, thereby realizing exact payment of the introduction fee to each introducer in compliance with the individual introduction record.

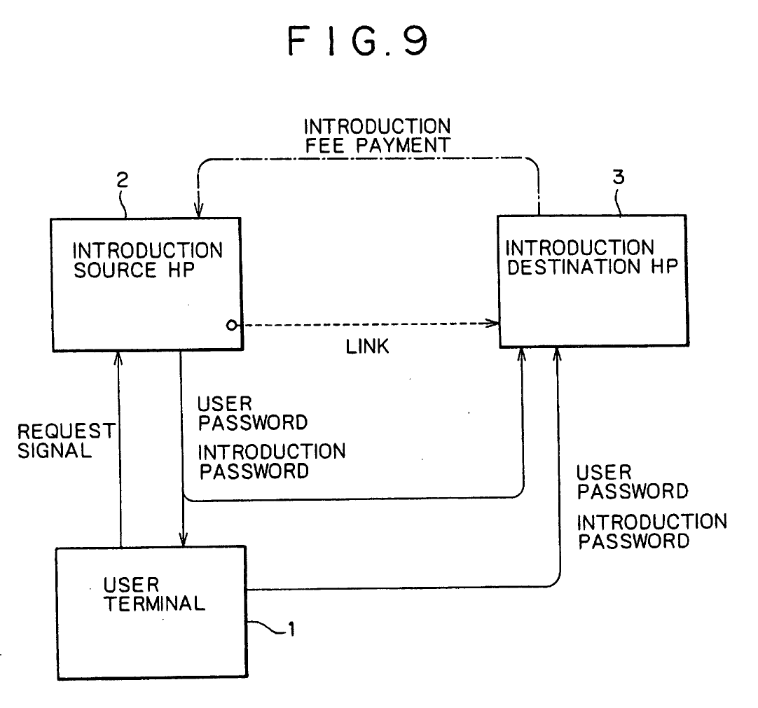

Now some modifications will be described below as other embodiments with reference to FIGS. 9-11.

FIG. 9 shows a structural example of a system comprising a user terminal 1, a source homepage 2 and a destination homepage 3, as in FIG. 1 mentioned above. This configuration is fundamentally the same as that of FIG. 1 with the exception that, when issuing a user password and an introduction password to the user terminal 1, the source homepage transmits such user password and introduction password also to the destination homepage 3.

In this example, hardware function blocks of the source homepage 2 are the same as those in FIG. 2, and therefore repeated illustration and explanation thereof are omitted here. However, the transmitter 26 shown in FIG. 2 transmits the user password and the introduction password as transmission data to both of the user terminal 1 and the destination homepage 3.

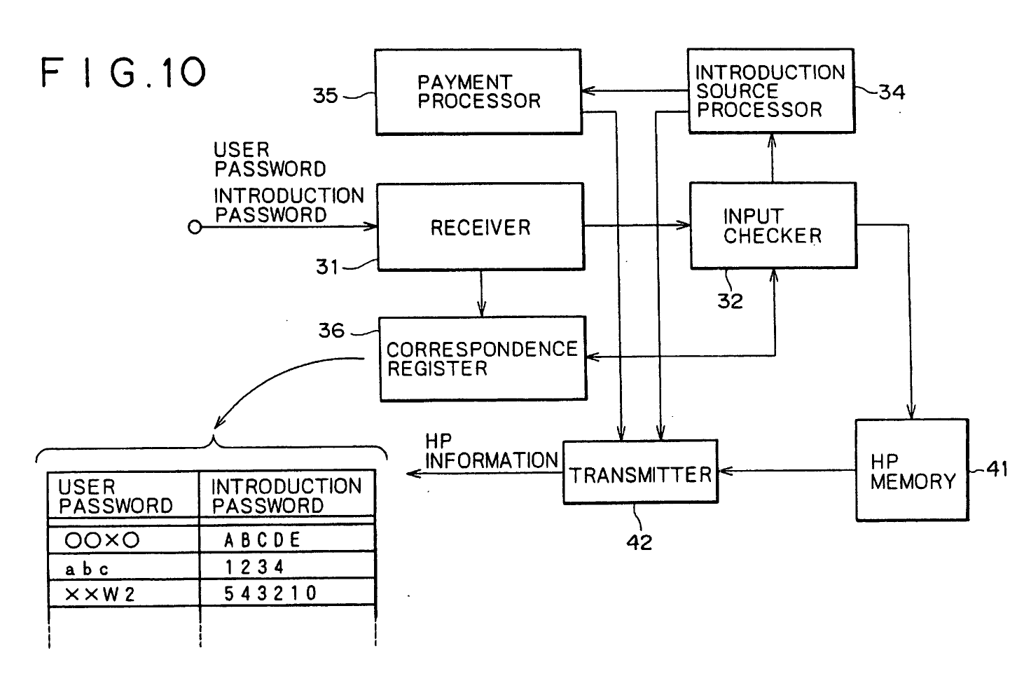

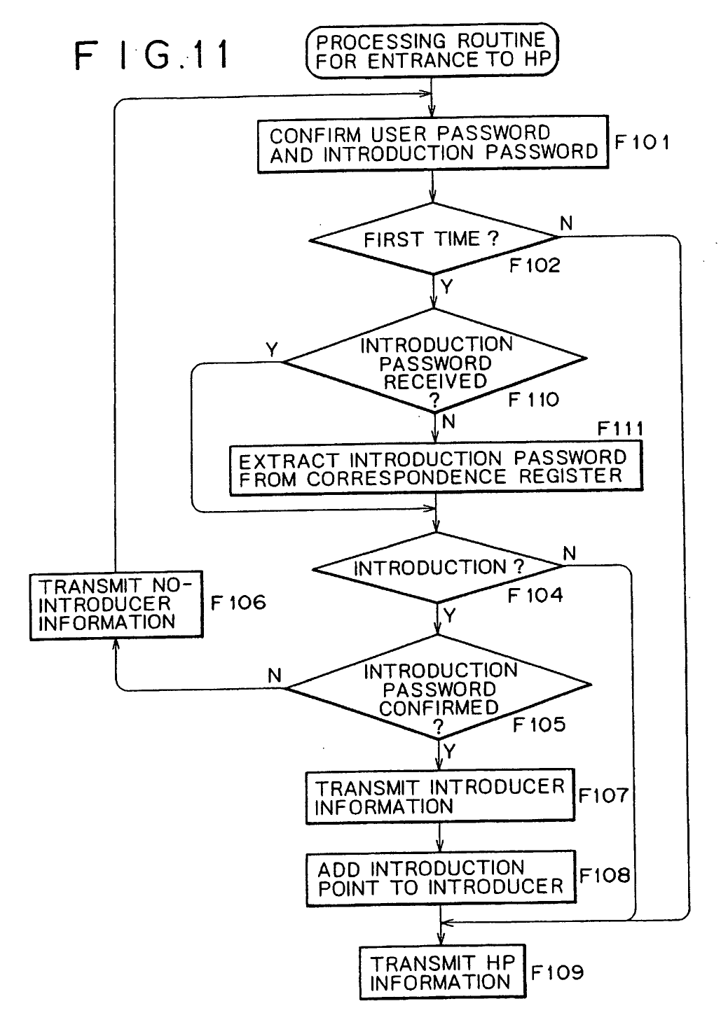

FIG. 10 shows hardware function blocks of the destination homepage 3. In this diagram, any blocks identical to those in FIG. 3 are denoted by the same reference numerals. The difference from the aforementioned configuration of FIG. 3 resides in that the user password register 33 is eliminated, and a correspondence register 36 is provided instead.

In this embodiment, as described above, the source homepage 2 transmits the user password and the introduction password also to the destination homepage 3 simultaneously with transmission of such user password and introduction password to the user terminal 1. Then the correspondence register 36 registers the transmitted user password and introduction password as a data base with mutual correspondence as shown in the diagram. At this time, the source homepage 2 transmits to the destination homepage 3 a signal having, in its header, the identifier of the source homepage 2 to indicate the user password and the introduction password transmitted from the source homepage 2. And upon reception of the signal having the identifier of the source homepage 2 in its header, the receiver 31 of the destination homepage 3 registers the user password and the introduction password in the data base stored in the correspondence register 36. The information thus registered is used for the processing executed by the input checker 32 in response to an access from the user terminal 1 to the destination homepage 3.

At entrance of the user terminal 1 to the destination homepage 3 in such a system, the processing routine of the destination homepage 3 is executed as shown in FIG. 11. In this diagram, any steps identical to those in FIG. 4 are denoted by the same reference numerals, and a repeated explanation thereof is omitted here.

In this case, when the input checker 32 decides the first entrance at step F102 in accordance with the result of a comparison between the user password in the data base of the correspondence register 36 and the user password received from the receiver 31, then another decision is made at step F110 as to whether the introduction password has been inputted or not, i.e., to confirm if the introduction password has been received or not from the user terminal 1 at the time point of step F101. For this purpose, the processing routine is so prepared that the receiver 31 confirms proper reception at step F101 regardless of transmission of the introduction password in a blank form from the user terminal 1.

And in the case of no reception of the introduction password, i.e., if a NULL signal has been received, the operation proceeds to step F111 to search the data base in the correspondence register 36, thereby extracting the introduction password corresponding to the user password. Thereafter the operation proceeds to step F104.

In case the introduction password has been received by the input checker 32, the operation proceeds directly to step F104. The following processing are the same as those in FIG. 4.

More specifically, in this processing routine, the proper introduction source can be discriminated without inputting the introduction password from the user terminal 1. In other words, it is possible for the user of the user terminal 1 to eliminate the necessity of inputting the introduction password and to attain the purpose merely by inputting the user password alone.

For this reason, even if the user of the user terminal 1 forgets the introduction password or neglects input thereof, it is still possible for the destination homepage 3 to discriminate the source homepage 2 properly, so that addition of an adequate introduction point can be carried out exactly at step F108.

Consequently, the destination homepage 3 is enabled to pay an appropriate amount of the introduction fee to each introducer by the introduction source processor 34 and the payment processor 35.

The processing routine of FIG. 11 may be so modified that, upon input of the user password at step F101, the succeeding operation is performed by searching the data base in the correspondence register 36, retrieving the corresponding introduction password, transmitting the introduction password to the user terminal 1, and displaying the introduction password automatically on the picture of FIG. 7 for example. In this modification, it becomes possible to visually notify the user that input of the introduction password is not necessary.

The processing routine described above can be executed by either hardware or software. In the case of executing the routine by software, a program constituting the software is installed in an exclusive hardware computer or a general-purpose computer.

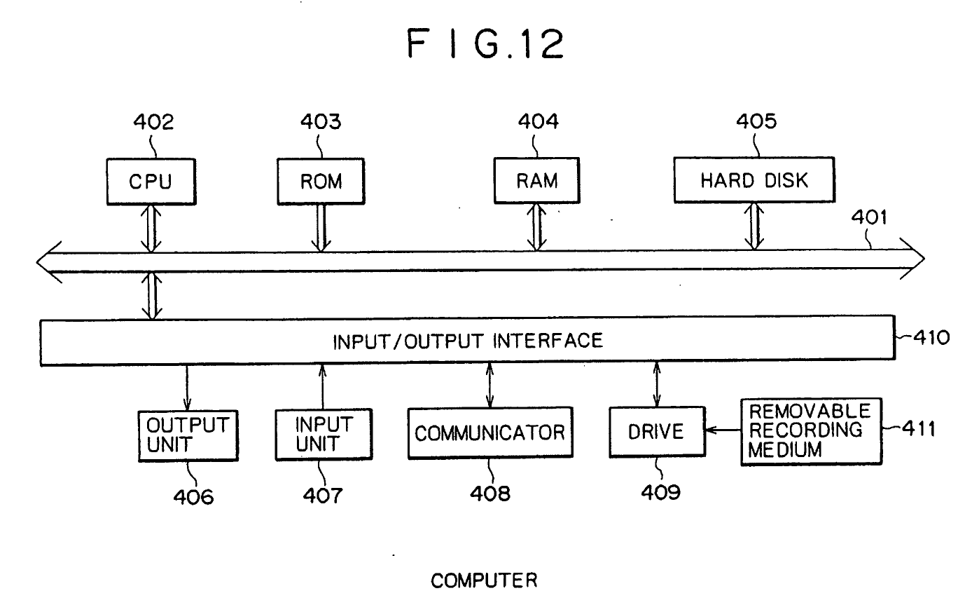

FIG. 12 shows a structural example of an embodiment which represents a computer where a program for executing the above processing routine is installed.

The program can be previously recorded in a hard disc 405 or a ROM 403 employed as a recording medium in the computer.

Further the program can be stored (recorded) either temporarily or permanently in a removable recording medium 411 such as floppy disc, CD-ROM (Compact Disc Read Only Memory), MO (Magneto-optical) disc, DVD (Digital Versatile Disc), magnetic disc or semiconductor memory. Such removable recording medium 411 can be provided as package software.

In addition to installation from such removable recording medium 411 into the computer, the program can be transferred by radio from a down-load site to the computer via a digital broadcasting satellite, or can be transferred by cable to the computer via a network such as the Internet. Then the computer can receive the transferred program by its communicator 408 and install the program in the internal hard disc 405.

The computer has an internal CPU (Central Processing Unit) 402. An input/output interface 410 is connected to the CPU 402 via a bus 401, and the CPU 402 executes a program, which is stored in a ROM (Read Only Memory) 403, in response to an input command received via the input/output interface 410 from an input unit 407 consisting of a keyboard, a mouse, a microphone and so forth manipulated by the user. In another case, the CPU 402 executes a program stored in a hard disc 405, or a program transferred thereto from a satellite or a network and received by a communicator 408 and installed in the hard disc 405, or a program read out from a removable recording medium 411 in a drive 409 and installed in the hard disc 405, after loading the relevant program in a RAM (Random Access Memory) 404. Consequently, the CPU 402 executes the processing shown in the flowchart of FIG. 4 or 11, or the processing carried out by the structure in the hardware function block diagram of FIG. 2, 3 or 10. And when necessary, the CPU 402 outputs the result of such processing from an output unit 406, which consists of an LCD (Liquid Crystal Display), a speaker and so forth, via the input/output interface 410, or transmits such result from the communicator 408, or records the result in the hard disc 405.

In this specification, the processing steps that describe the program for enabling the computer to carry out such routines need not exactly be executed in time series according to the sequence mentioned in the flowchart, and such steps include also the processes executed in parallel or individually (e.g., parallel processing or object processing).

It is also to be understood that the program may be executed by a single computer or plural computers distributedly. Further, the program may be transferred to and executed by a remote computer as well.

Although the preferred embodiments of the present invention have been explained above with regard to the structural and processing examples, a variety of modifications thereof may also be contrived.

First, in the examples mentioned, entrance to the homepage is rendered possible without the necessity of a user password and an introduction password. However, inputting such passwords may be adopted as a requisite for entrance to the homepage.

Entrance to the homepage 3 is permitted without a user password and an introduction password. But in the case of entrance to the homepage without any password, readable pages may be limited in the homepage.

In regard to such limitation of entrance and reading, the present invention is considered to be applicable in such a manner that the user password and the introduction password are utilized not for the purpose of paying an introduction fee or the like, but for the principal purpose of limiting entrance or reading under a membership system of homepages.

In each of the aforementioned embodiments, an introduction point is added to an introducer for the first entrance due to an introduction. However, an introduction point may be added for the second or subsequent entrance as well. It is a matter of course that the introduction point to be added to the introducer may be different in value depending on the first and the second or subsequent entrance.

Further, in case the destination homepage 3 is one for sales of commodities for example, an introduction point may be added when any entered user has purchased a commodity.

Due to such processing, the system is enabled to comply flexibly with actual circumstances including the relationship between the introducer and the introducee, the contents of the destination homepage 3, and the contents of the source homepage 2.

Although the source homepage 2 and the destination homepage 3 are shown individually in each of the above embodiments, the configuration may be so modified that one homepage serves as an introduction source for the other homepage and further as an introduction destination from the other homepage.

Such homepages may be equipped with both of the functions shown in FIG. 2 and FIG. 3 (or FIG. 10) respectively.

The user is permitted to enter the destination homepage 3 by execution of the processing routine in FIG. 4 or 10. In this case, an introduction password may be given to the user in the destination homepage.

That is, when a certain user likes the content of the destination homepage 3 and desires to introduce it to some other person, the user registers himself on the registration picture prepared in the destination homepage 3, and requests issue of the introduction password thereto. Then it becomes possible for the user to enable the homepage of his own to function in the same manner as the source homepage 2.

The source homepage 2 in each of the above embodiments gives a user password or an introduction password to the user in response to a registration of the user. However, such registration may not be a requisite for issue of a password.

In some cases, an introduction password may be presented on the source homepage 2 so that any user having accessed thereto can know such password.

Further, a user password may be issued from the destination homepage 3 to each of the individual users having accessed thereto, while such a user password is not issued from the source homepage 2. For example, it is so determined that an introduction password is necessary when a user password is to be issued from the destination homepage 3, whereby a correspondence is attained between the introduction password and the user password to consequently realize proper payment of an introduction fee or the like.

In another case, the user password may be self-registered by the user him/herself.

Besides the above, a variety of processes using an introduction password may be contrived in such a manner that, when one user for example has entered the destination homepage 3 by using the introduction password, the relevant user is registered as a member of a group where the introducer is a leader, and then the user performs activity of inviting new participants to the group or holding an explanatory meeting. In this case, a bonus point may be added to the leader or any relevant individual person of the group in accordance with the result of such activity, whereby the point is given back as a profit.

While a preferred embodiment of the present invention has been described using specific terms, such description is for illustrative purposes only, and it is to be understood that changes and variations may be made without departing from the spirit or scope of the following claims.

1.-9. (canceled)

10. An information processing apparatus capable of transmitting homepage information to a terminal device, comprising:
a receiver for receiving a request signal transmitted from the terminal device requesting issue of a user password and an introduction password indicating a generation source of the user password, and for receiving individual user information transmitted from terminal device;
a user register for storing the received individual user information;
a user password generator for generating a user password corresponding to the received individual user information and for transferring the generated user password to the user register where the transferred user password is stored correspondingly to the individual user information;
an introduction password memory for storing an introduction password to identify the homepage information; and
a transmitter for transmitting the generated user password and the introduction password to the terminal device.

11. An information processing apparatus capable of transmitting information to a terminal device, comprising:
receiving means for receiving a user identifier transmitted from the terminal device and generation source identifier indicating a generation source of the user identifier;
authenticating means for authenticating an access to the information in accordance with the received user identifier and generation source identifier; and
payment processing means for executing a process to pay a fee to the generation source indicated by the generation source identifiers in accordance with the result of the authentication.

12. The information processing apparatus according to claim 11, wherein the authenticating means comprises an input checker for deciding whether a reception of the user identifier is an initial reception, and a user identifier register for storing user identifiers previously received and registering user identifiers having receptions decided to be initial receptions by the input checker.

13. The information processing apparatus according to claim 11, wherein the authenticating means comprises a generation source processor for outputting either of generation source information and no-generation source information in accordance with the a result of a comparison between the received generation source identifier and a stored generation source identifier.

14. The information processing apparatus according to claim 13, wherein the generation source processor updates a point value that corresponds to the generation source identifier indicating the generation source in accordance with the result of the comparison.

15. The information processing apparatus according to claim 14, further comprising homepage information storage means for storing homepage information, wherein the payment processing means converts the point value stored in the generation source processor into an amount of money and generates a signal for payment of the amount of money to the generation source indicated by the generation source identifier, the signal serving as a settlement signal having an identifier corresponding to a homepage of a payment source, an account number corresponding to the generation source identifier, and information of the amount.

16. The information processing apparatus according to claim 11, wherein the authenticating means comprises: a correspondence register for registering the received user identifier and the generation source identifier correspondingly in a database when the received user identifier and the generation source identifier have been transferred from the information processing apparatus having an introduction source homepage to introduce the information; and an input checker for deciding whether the reception of the user identifier is an initial reception in accordance with the database.

17. The information processing apparatus according to claim 16, wherein the input checker decides whether the generation source identifier has been received and retrieves the generation source identifier corresponding to the user identifier from the database of the correspondence register when the decision indicates that the generation source identifier has not been received.

18. An information processing apparatus capable of transmitting homepage information to a terminal device, comprising:
a receiver for receiving a user password and an introduction password indicating a generation source of the user password from the terminal device;
an input checker for deciding whether the reception of the user password is initial reception, and for deciding whether the introduction password received is proper;
a user password register for storing user passwords previously received by the receiver, and for registering new passwords when the input checker decides the new passwords have not been previously received;
an introduction source processor for outputting either of introducer information and no-introducer information in accordance with a result of a comparison between the received introduction password and a stored introduction password, and for updating a point value which that corresponds to the introduction password indicative of the generation source in accordance with the result;
a homepage information memory for storing homepage information in an HTML format;
a payment processor for converting the point value stored in the introduction source processor, into an amount of money, wherein the payment processor generates a settlement signal having an identifier corresponding to a homepage of a payment source, an account number corresponding to the introduction password, and information of the amount; and
a transmitter for transmitting to the terminal device either of the introducer information and the no-introducer information outputted from the introduction source processor for transmitting the homepage information to the terminal device; and for transmitting the generated settlement signal to a settlement center.

19. An information processing apparatus capable of transmitting homepage information to a terminal device, comprising:
a receiver for receiving a user password and an introduction password indicating a generation source of the user password from the terminal device;
a correspondence register for registering the user password and the introduction password correspondingly in a database when the received user password and introduction password have been transferred from an information processing apparatus that owns an introduction source homepage for introducing the homepage;
an input checker for deciding whether the reception of the user password by said receiver is the an initial reception by searching the database of the correspondence register wherein the input checker retrieves an introduction password corresponding to the user password from the database of correspondence register when the decision indicates the user password has been previously received;
an introduction source processor for outputting either of introducer information and no-introducer information in accordance with a result of a comparison between either of the received and retrieved introduction password and the stored introduction password, and for updating a point value that corresponds to the introduction password indicative of the generation source in accordance with the result;
a homepage information memory for storing homepage information in an HTML format;
a payment processor for converting the point value stored in the introduction source processor into an amount of money, wherein the payment processor generates a settlement signal having an identifier corresponding to a homepage of a payment source, an account number corresponding to the introduction password, and information of the amount; and
a transmitter for transmitting, to the terminal device either of the introducer information and the no-introducer information outputted from the introduction source processor for transmitting the homepage information to the terminal device and further for transmitting the generated settlement signal to a settlement center.

20. (canceled)

21. An information processing method comprising the steps of:
receiving a user identifier transmitted from a terminal device and a generation source identifier indicating a generation source of the user identifier;
authenticating access to information stored in an information processing apparatus in accordance with the received user identifier and generation source identifier; and
executing a process for paying a fee to the generation source indicated by said generation source identifier in accordance with a result of the authenticating step.
